(19) United States
(12) Patent Application Publication
(10) Pub. No.: US 2026/0269996 A1
(43) Pub. Date: Sep. 10, 2026

(54) PDSCH AND PUSCH FDRA ENHANCEMENTS FOR SUBBAND FULL DUPLEX

(71) Applicant: MediaTek Singapore Pte. Ltd., Singapore (SG)

(72) Inventors: Sumaila Anning MAHAMA, Cambridge (GB); Jozsef Gabor NEMETH, Cambridge (GB); Mohammed S Aleabe AL-IMARI, Cambridge (GB)

(21) Appl. No.: 19/163,626

(22) PCT Filed: Apr. 2, 2024
(86) PCT No.: PCT/CN2024/085553

§ 371 Date: Sep. 9, 2025

Related U.S. Application Data
(60) Provisional application No. 63/494,483, filed on Apr. 6, 2023.

(51) Int. Cl. H04L 5/00; H04W 72/0453; H04W 72/1273

(52) U.S. Cl. CPC H04L 5/0044; H04W 72/0453; H04W 72/1273

(57) ABSTRACT

Techniques pertaining enhancements for physical data shared channel (PDSCH) and physical uplink shared channel (PUSCH) frequency domain resource allocation (FDRA) in subband full duplex (SBFD) are described. Such techniques include configuring a UE to consider a resource block (RB) allocation for a SBFD partitioned slot that includes one or more RBs that are outside of one or more downlink subbands to be an invalid RB allocation when RB allocations outside of downlink subbands are determined to be not allowed on SBFD partitioned slots for Type-0 and Type-1 PDSCH FDRA. The techniques further include providing the RB allocation that includes the one or more RBs that are outside of the one or more downlink subbands.

### CROSS REFERENCE TO RELATED PATENT APPLICATION(S)

The present disclosure is part of a non-provisional application claiming the priority benefit of U.S. Patent Application No. 63/494,483, filed 6 Apr. 2023, the content of which herein being incorporated by reference in its entirety.

### TECHNICAL FIELD

The present disclosure is generally related to mobile communications and, more particularly, to techniques for frequency domain resource allocation (FDRA) in subband full duplex (SBFD).

### BACKGROUND

Unless otherwise indicated herein, approaches described in this section are not prior art to the claims listed below and are not admitted as prior art by inclusion in this section.

Frequency-domain resources for physical data shared channel (PDSCH) and physical uplink shared channel (PUSCH) may be allocated dynamically through downlink control information (DCI), using either Type-0 or Type-1 frequency domain resource allocation (FDRA). Type-0 FDRA is based on a bitmap where each bit of the bitmap represents a resource block (RB) group in a resource allocation (e.g., a SBFD partitioned slot), in which the RB size of the RB group is dependent on a bandwidth part (BWP) size. A SBFD partitioned slot is a slot that is partitioned to include downlink subbands and uplink subbands. Accordingly, Type-0 FDRA can be readily used to provide flexible and non-contiguous RB allocations, which may be required in SBFD operation to allocate RBs from multiple non-contiguous DL subbands. In contrast, type-1 FDRA is based on a starting RB and an RB length over a contiguous set of PRBs in a SBFD partitioned slot.

In some instances, RB allocations for both FDRA types may need to cover beyond the respective downlink subbands (DL-SB) or uplink subbands (UL-SB) in a SBFD partitioned slot. For example, FDRA may need to be configured to indicate RB allocations outside the DL-SB and the UL-SB for PDSCH and PUSCH, respectively. This will enable DL reception in UL-SB and/or UL transmission in the DL-SB. However, some enhancements may be needed in order to enable FDRA to indicate RBs that cover beyond the DL-SB and UL-SB for DL and UL allocations, respectively.

For Type-1 PDSCH allocation, virtual resource blocks (VRBs) may be mapped to a set of physical resource blocks (PRBs) using either non-interleaved mapping or interleaved mapping. VRB-to-PRB mapping uses the concept of resource block bundling. For example, the parameter vrb-ToPRB-Interleaver within a PDSCH-Config configuration of a PDSCH may configure a bundle size of either 2 or 4, in which RB bundles are formed over contiguous VRBs such that VRBs within a bundle are mapped to contiguous PRBs and their order do not change. However, RB bundles at lower and upper ends of a BWP may contain fewer RBs. Furthermore, VRB bundles are mapped to PRB bundles using an interleaving function, in which the interleaving depends on the number of RBs within the DL BWP.

Nevertheless, there may be some issues with such VRB bundling and interleaving with respect to SBFD partitioned slots. For example, since the VRB bundling is across a contiguous set of RBs within a DL BWP, such VRB bundling is not suitable for SBFD partitioned slots with two non-contiguous DL subbands. Another issue is that an interleaving function is not suitable for VRB-to-PRB mapping over two DL subbands, as such mapping may overlap with UL subband.

### SUMMARY

The following summary is illustrative only and is not intended to be limiting in any way. That is, the following summary is provided to introduce concepts, highlights, benefits, and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the issue(s) described herein. More specifically, various schemes proposed in the present disclosure are believed to provide solutions that resolve several problems associated with techniques for FDRA in SBFD.

In one aspect, a method may include configuring, by a processor, a UE to consider an RB allocation for a SBFD partitioned slot that includes one or more RBs that are outside of one or more downlink subbands to be an invalid RB allocation when RB allocations outside of downlink subbands are determined to be not allowed on SBFD partitioned slots for Type-0 and Type-1 PDSCH FDRA. The method may further include providing, by the processor, the RB allocation that includes the one or more RBs that are outside of the one or more downlink subbands.

In another aspect, a method may include configuring, by a processor, a UE to consider an RB allocation for a SBFD partitioned slot that includes one or more RBs that are outside of one or more uplink subbands to be an invalid RB allocation when RB allocations outside of uplink subbands are determined to be not allowed on SBFD partitioned slots for Type-0 and Type-1 PUSCH FDRA. The method may further include providing, by the processor, the RB allocation that includes the one or more RBs that are outside of the one or more uplink subbands to the UE.

In yet another aspect, an apparatus may include a transceiver and a processor coupled to the transceiver. The transceiver may be configured to communicate wirelessly. The processor may perform at least one operation of a plurality of operations, in which the plurality of operations comprise allocating one or more RBs of a PRG that do not overlap with one or more uplink subbands of a SBFD partitioned slot for downlink transmission when the PRG overlaps with one or more uplink subbands of the SBFD partitioned slot.

It is noteworthy that, although the description provided herein may be in the context of certain radio access technologies, networks, and network topologies such as 5G/NR/Beyond Fifth-Generation (B5G) mobile communications, the proposed concepts, schemes and any variation(s)/derivative(s) thereof may be implemented in, for and by other types of radio access technologies, networks and network topologies such as, for example and without limitation, Long-Term Evolution (LTE), LTE-Advanced, LTE-Advanced Pro, Internet-of-Things (IoT), Narrow Band Internet of Things (NB-IoT), Industrial Internet of Things (IIoT), vehicle-to-everything (V2X), and non-terrestrial network (NTN) communications. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example network environment in which various proposed schemes in accordance with the present disclosure may be implemented.

FIG. 2 illustrates some aspects related to an example proposed scheme in accordance with the present disclosure.

FIG. 3 illustrates some other aspects related to an example proposed scheme in accordance with the present disclosure.

FIG. 4 illustrates some additional aspects of an example proposed scheme in accordance with the present disclosure.

FIG. 5 illustrates some further aspects of an example proposed scheme in accordance with the present disclosure.

FIG. 6 illustrates some more aspects of an example proposed scheme in accordance with the present disclosure.

FIG. 7 is a block diagram of an example communication system in accordance with an implementation of the present disclosure.

FIG. 8 is a flowchart of a first example process in accordance with an implementation of the present disclosure.

FIG. 9 is a flowchart of a second example process in accordance with an implementation of the present disclosure.

FIG. 10 is a flowchart of a third example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that the description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to enhancements for PDSCH and PUSCH FDRA in SBFD. According to the present disclosure, a number of possible solutions may be implemented separately or jointly. That is, although these possible solutions may be described below separately, two or more of these possible solutions may be implemented in one combination or another.

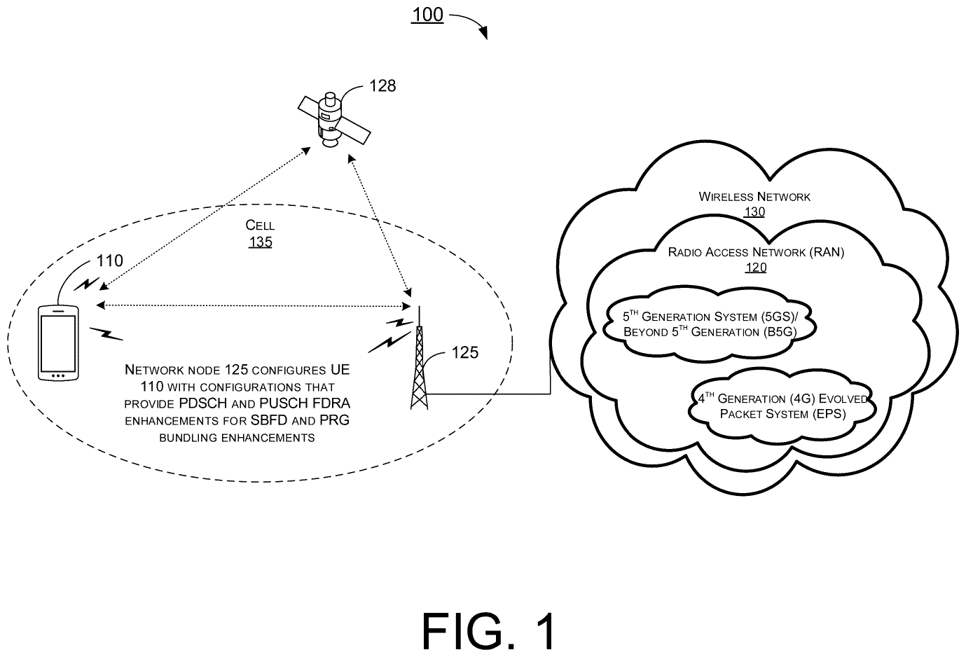

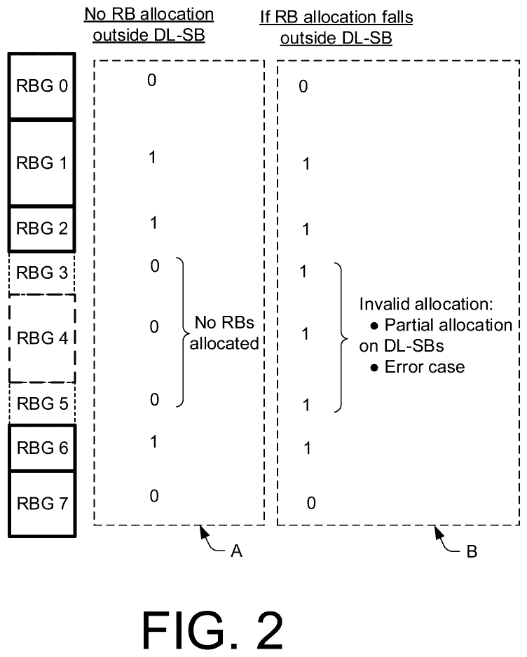

FIG. 1 illustrates an example network environment 100 in which various solutions and schemes in accordance with the present disclosure may be implemented. FIG. 2-FIG. 10 illustrate examples of implementation of various proposed schemes in network environment 100 in accordance with the present disclosure. The following description of various proposed schemes is provided with reference to FIG. 1-FIG. 10.

As shown in FIG. 1, network environment 100 may include a UE 110 in wireless communication with a RAN 120 (e.g., a 5G NR mobile network, a B5G mobile network, or another type of network such as an NTN). UE 110 may be in wireless communication with RAN 120 via a network node 125 (e.g., an eNodeB, gNodeB, or transmit-receive point (TRP)) and/or a non-terrestrial network node 128 (e.g., a satellite). That is, UE 110 may be within coverage of a cell 135 associated with terrestrial network node 125 or non-terrestrial network node 128. RAN 120 may be a part of a network 130. In network environment 100, UE 110 and network 130 (via network node 125 of RAN 120) may implement various schemes that provide enhancements to PDSCH and PUSCH FDRA in SBFD.

It is noteworthy that, although various proposed schemes, options, and approaches may be described individually below, in actual applications these proposed schemes, options, and approaches may be implemented separately or jointly. That is, in some cases, each of one or more of the proposed schemes, options, and approaches may be implemented individually or separately. In other cases, some or all of the proposed schemes, options, and approaches may be implemented jointly.

In a first sub-scheme of a first proposed scheme in accordance with the present disclosure, PDSCH FDRA is not allowed outside downlink subbands. Thus, in this first sub-scheme of the first proposed scheme, RB allocation that is outside downlink subband(s) is not allowed on SBFD partitioned slots and/or symbols for both Type-0 and Type-1 PDSCH FDRA. For example, as shown Part A of FIG. 2, the resource block group (RBG) flag for Type-0 PDSCH FDRA may be set to “0” by a network node (e.g. network node 125) in a bitmap for RBGs (e.g., RBGs 3, 4, and 5) that fall outside of the downlink subband(s) of a SBFD partitioned slot. Alternatively with respect to a Type-1 PDSCH FDRA, a start RB and an RB length for the Type-1 PDSCH FDRA may be configured by the network node such that the RB allocation may be within downlink subband(s) of the SBFD partitioned slot.

Thus, as shown in Part B of FIG. 2, a UE (e.g., the UE 110) may be configured to consider an RB allocation that includes one or more RBs that are outside the downlink subband(s), of the SBFD partitioned slot as an invalid RB allocation. Such an invalid RB allocation may be treated differently by the UE depending on the configuration of the UE and the nature of the RB allocation, such that the UE may attempt to salvage the invalid RB allocation or disregard the invalid RB allocation.

In some instances in which the UE is configured to salvage an invalid RB allocation, the invalid RB allocation may include RBs of one or more RBGs of a Type-0 PDSCH FDRA that overlap with downlink subband(s) and RBs of one or more RBGs that fall outside of the downlink subband(s) of the SBFD partitioned slot. For example, the one or more RBGs that fall outside of the downlink subband(s) may overlap with one or more uplink subbands and/or one or more guard bands of the SBFD partitioned slot. Thus, the UE may ignore the allocation of the RBs of the one or more RBGs that fall outside of the downlink subband(s) and consider the invalid RB allocation to be a valid partial RB allocation of RBs in the one or more RBGs that overlap with the downlink subband(s) of the SBFD partitioned slot. For example, with respect to Part B of FIG. 2, the UE may consider the invalid RB allocation of the RBs in RBGs #1-#6 to be a valid partial RB allocation of the RBs in RBGs #1, #2, and #6.

Furthermore, in at least one of such instances, the RB allocation may include the allocation of one or more particular RBGs of the Type-0 PDSCH FDRA that partially fall outside, i.e., does not overlap with the downlink subband(s). For example, a particular RBG may include one or more RBs (e.g., two RBs) that overlap with the downlink subband(s), and one or more RBs (e.g., two RBs) that overlap with one or more uplink subbands and/or one or more guard bands. In these instances, the UE may be configured to consider the one or more RBs of particular RBG that overlap with downlink subband(s) to be a valid partial RB allocation. Thus, in such instances, the UE may consider the invalid RB allocation to be a valid partial RB allocation that include the RBs of the one or more such particular RBGs that overlap with the downlink subband(s), as well as any RBs of whole RBGs that are included in the invalid RB allocation that overlap with the downlink subband(s) of the SBFD partitioned slot.

In other instances in which the UE is configured to salvage an invalid RB allocation for a Type-1 PDSCH FDRA that is designated by a start RB and a RB length, the UE may disregard any RB (PRB) of the invalid RB allocation that falls outside of the downlink subband(s) of a SBFD partitioned slot and then consider such an invalid RB allocation to be a valid partial RB allocation of RBs (PRBs) that fall within the downlink subband(s) of the SBFD partitioned slot.

However, in alternative instances, the UE may be further configured to consider any invalid RB allocation that includes one or more RBs that are outside the downlink subband(s) of a SBFD partitioned slot to be an error case. As a result, the UE may disregard the invalid RB allocation because it is an error case.

In a second sub-scheme of the first proposed scheme in which PDSCH FDRA is not allowed outside downlink subbands, VRB-to-PRB mapping by the UE may exclude PRBs that are outside the downlink subband(s) for Type-1 PDSCH FDRA on SBFD partitioned slots/symbols. The excluded PRBs may be PRBs that belong to one or more uplink subbands and/or one or more guard bands.

In order to perform such an exclusion of PRBs, the total number of VRBs that are in a single contiguous VRB range as indicated by current start and length indicator value (SLIV) rules is given by the total number of PRBs in the downlink subbands of the SBFD partitioned slot. The total number of PRBs in the downlink subbands may be configured explicitly or implicitly. For example, the total number of PRBs may be determine as:

$${N}_{RB , i}^{DL \_ size} = {N}_{BWP , i}^{size} - ( {N}_{RB , i}^{UL \_ size} + {N}_{RB , i}^{GB \_ size} )$$

in which

$${N}_{RB , i}^{DL \_ size}$$

is the total number of RBs in the downlink subband(s),

$${N}_{BWP , i}^{s i z e}$$

is the total number if RBs in BWP i,

$${N}_{RB , i}^{UL \_ size}$$

is the number of RBs in the uplink subband(s) and

$${N}_{RB , i}^{GB \_ size}$$

is the total number of RBs in the guard bands (if any).

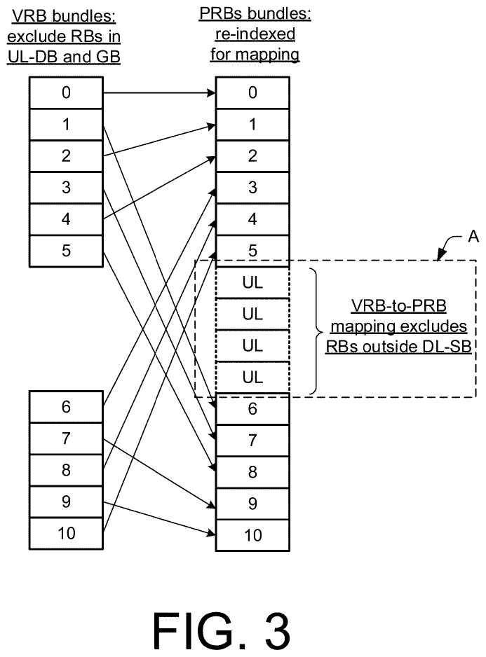

In various instances, the PRBs are reindexed for mapping by leaving out PRBs that are unavailable for downlink allocation based on the SBFD configuration indicated to the UE by the network node. For example, the PRB may be reindexed by numbering the PRBs contiguously over the downlink subband(s) by excluding PRBs on uplink subband(s) and guard bands. For example, as shown in Part A of FIG. 3, PRB bundles of a SBFD partitioned slot that are outside of the downlink subband(s) are excluded from VRB-to-PRB mapping. Thus, while there are 14 PRB bundles, the PRB bundles are reindexed with index values #1-#10. In some of these instances, VRB-interleaving is disabled for the SBFD partitioned slot/symbols.

However, in others of these instances, VRB-interleaving may be enabled such that the interleaved mapping follows the existing VRB-to-PRB interleaving functions and/or procedures with some modification. For example, in some implementations, the number of VRB bundles in a BWP is obtained by replacing

$${N}_{BWP , i}^{size} with {N}_{RB , i}^{DL \_ size} ,$$

such that:

$${N}_{bundle} = ⌈ ( {N}_{RB , i}^{DL \_ size} + ( {N}_{BWP , i}^{start} mod {L}_{i} ) ) / {L}_{i} ⌉$$

where Lᵢ is the bundle size. In at least one instance, PRB bundles (with bundle size of 2 or 4 RBs) may be formed using the reindexed set of PRBs, in which PRB bundle N_{bundle}−1 consists of

$$( {N}_{B WP , i}^{start} + {N}_{RB , i}^{DL \_ size} )$$

### mod Lᵢ RBs if

$$( {N}_{B WP , i}^{start} + {N}_{RB , i}^{DL \_ size} )$$

mod Lᵢ>0. In such instances, the network node may be configured to ensure that the allocated RBs and corresponding mapping (for both non-interleaved and interleaved cases) do not fall outside the downlink subband(s).

In a third sub-scheme of the first proposed scheme in which PDSCH FDRA is not allowed outside downlink subbands, VRB-to-PRB mapping may be performed by the UE separately for each downlink subband of a SBFD partitioned slot/symbol for Type-1 PDSCH FDRA with interleaving. In various instances, for each set of contiguous RBs, the UE may first apply indices

$$0 … {N}_{RB , i}^{DL \_ size , j} - 1$$

to allocated VRBs and PRBs, where

$${N}_{RB , i}^{DL \_ size , j}$$

is the RB size of j^{th} subband on the i^{th} bandwidth part. The interleaved mapping for the j^{th} subband may follow the existing VRB-to-PRB interleaving functions and/or procedures with some modification. For example, the number of bundles in the j^{th} subband may be obtained by replacing

$${N}_{BWP , i}^{s i z e} with {N}_{RB , i}^{DL\_size , j} :$$

$${N}_{bundle}^{j} = ⌈ ( {N}_{RB , i}^{DL \_ size , j} + ( {N}_{BWP , i}^{start , j} mod {L}_{i} ) ) / {L}_{i} ⌉$$

in which

$${N}_{B WP , i}^{start , j}$$

is the start RB for the j^{th} subband and Lᵢ is the bundle size. In at least one instance, VRB and PRB bundles (with PRB bund size of 2 or 4 RBs) may be formed per downlink subband, and PRB bundle

$${N}_{b u n d l e}^{j} - 1$$

consists of

$$( {N}_{B WP , i}^{start} + {N}_{RB , i}^{DL \_ size , j} )$$

### mod Lᵢ RBs if

$$( {N}_{B WP , i}^{start} + {N}_{RB , i}^{DL \_ size , j} )$$

mod Lᵢ>0 Furthermore, when a VRB or PRB bundle partially overlaps with an uplink subband, the non-overlapping RBs within the VRB or PRB bundle may be allocated for downlink transmission. In some instances, PRB bundle at edge of a downlink subband may have a smaller number of RBs compared to other PRB bundles.

In a first sub-scheme of a second proposed scheme in which PDSCH FDRA is allowed outside downlink subbands, RB allocation of one or more RBs outside downlink subband(s) is allowed on SBFD partitioned slots/symbols. In such a sub-scheme, RBG flag for Type-0 PDSCH FDRA may be set by a network node to “1” for RBGs that fall outside downlink subband(s). Alternatively, the start RB and the RB length for the Type-1 PDSCH FDRA may be configured by the network node such that the RB allocation includes RBs outside the downlink subband(s). Thus, a new parameter may be configured by the network node and sent to the UE to indicate to the UE whether an RB allocation that includes one or more RBs outside the downlink subband(s) of a SBFD partitioned slot may be considered by the UE as a valid RB allocation or an invalid RB allocation. For example, a bit field may be introduced in the DCI to dynamically indicate if an RB allocation that includes one or more RBs outside the downlink subband(s) is to be considered as a valid RB allocation or an invalid RB allocation. Alternatively, a higher layer parameter (e.g., a radio bearer configuration (RRC) parameter) may be configured to semi-statically indicate that the RB allocation that includes one or more RBs outside the downlink subband(s) is to be considered as a valid RB allocation or an invalid RB allocation.

Thus, the UE may be configured to consider an RB allocation that includes one or more RBs outside the downlink subband(s) of a SBFD partitioned slot as an invalid RB allocation when the bit field is absent from the DCI. In some instances of this scenario, the UE may consider any allocated RBs of an invalid RB allocation that falls within, i.e., overlaps with the downlink subband(s) as a valid partial RB allocation. In other instances of this scenario, the UE may consider an RB allocation that includes one or more RBs that fall outside of the downlink subband(s) to be an invalid RB allocation that is an error case. As a result, the UE may disregard the invalid RB allocation because it is an error case.

However, when the bit field is present in the DCI, the UE may determine whether the RB allocation that includes one or more RBs outside of the downlink subband(s) of a SBFD partitioned slot is to be considered as a valid RB allocation or an invalid RB allocation based on a value included in the bit field. For example, when a first bit value (e.g., “0”) is present, the UE may be configured to consider an RB allocation that includes one or more RBs that are outside of the downlink subband(s) to be an invalid RB allocation. In some instances of this scenario, the UE may consider any allocated RBs of an invalid RB allocation that falls within, i.e., overlaps with the downlink subband(s) as a valid partial RB allocation. In other instances of this scenario, the UE may consider an RB allocation that includes one or more RBs that fall outside of the downlink subband(s) to be an invalid RB allocation that is an error case. As a result, the UE may disregard the invalid RB allocation because it is an error case.

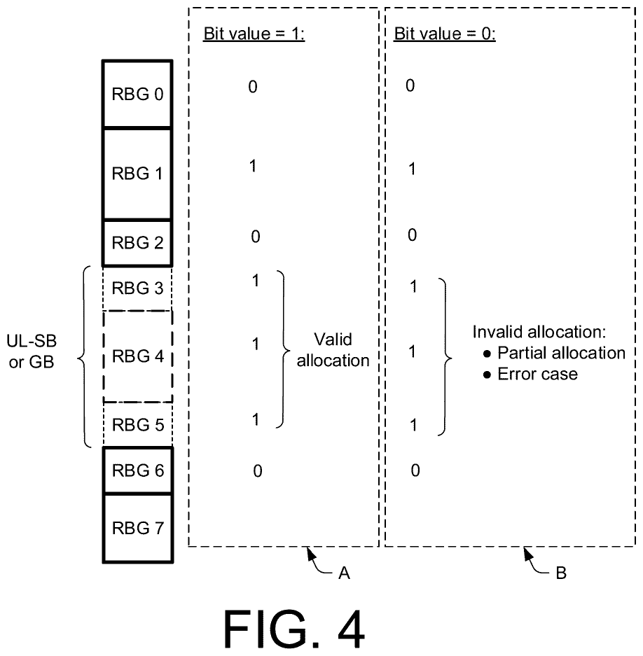

However, when the bit value that is present in the bit field of the DCI is a second value (e.g., “1”), the UE may be configured to consider an RB allocation that includes one or more RBs that are outside of the downlink subband(s) to be a valid RB allocation. For such a valid RB allocation, the UE may use all of allocated RBs of the RB allocation, i.e., the full allocation, for downlink data transmission regardless of whether each of the allocated RBs in the RB allocation is within or outside the downlink subband(s) of the SBFD partitioned slot. For example, this contrast between the presence of bit value “0” and bit value “1” is illustrated in FIG. 4 for Type-0 PDSCH FDRA, in which Part A corresponds to when the bit value “1” is present, and Part B corresponds to when the bit value “0” is present.

In a second sub-scheme of the second proposed scheme in which PDSCH FDRA is allowed outside downlink subbands, whether the bit value is set to a first value (e.g., “0”) or a second value (e.g., “1”) may also impact the VRB-to-PRB mapping for Type-1 PDSCH FDRA. For example, when the bit value is a first value (e.g., “0”) and the UE is configured to salvage, if possible, any invalid RB allocation as a partial RB allocation, the network node may also apply the second sub-scheme or the third sub-scheme of the first proposed scheme for VRB-to-PRB mapping for Type-1 PDSCH FDRA. However, when the bit value is a second value (e.g., “1”) and the UE is configured to consider any RB allocation that includes one or more RBs that are outside of the downlink subband(s) to be a valid RB allocation, i.e., as a full allocation, the UE may apply existing VRB-to-PRB mapping functions and/or procedures as specified in the 3GPP specifications for Type-1 PDSCH FDRA.

In a first sub-scheme of a third proposed scheme in accordance with the present disclosure, PUSCH FDRA is not allowed outside uplink subbands. Thus, in this first sub-scheme of the third proposed scheme, RB allocation that is outside downlink uplink(s) is not allowed on SBFD partitioned slots and/or symbols for both Type-0 and Type-1 PUSCH FDRA. For example, the resource block group (RBG) flag for Type-0 PUSCH FDRA may be set to “0” by a network node (e.g. network node 125) in a bitmap for RBGs that fall outside of the uplink subband(s) of a SBFD partitioned slot. Alternatively with respect to a Type-1 PUSCH FDRA, a start RB and an RB length for the Type-1 PUSCH FDRA may be configured by the network node such that the RB allocation may be within uplink subband(s) of the SBFD partitioned slot.

Thus, a UE (e.g., the UE 110) may be configured to consider an RB allocation that includes one or more RBs that are outside the uplink subband(s) of the SBFD partitioned slot as an invalid RB allocation. Such an invalid RB allocation may be treated differently by the UE depending on the configuration of the UE and the nature of the RB allocation, such that the UE may attempt to salvage the invalid RB allocation or disregard the invalid RB allocation.

In some instances in which the UE is configured to salvage an invalid RB allocation, the invalid RB allocation may include RBs of one or more RBGs of a Type-0 PUSCH FDRA that overlap with uplink subband(s) and RBs of one or more RBGs that fall outside of the uplink subband(s) of the SBFD partitioned slot. For example, the one or more RBGs that fall outside of the uplink subband(s) may overlap with one or more downlink subbands and/or one or more guard bands of the SBFD partitioned slot. Thus, the UE may ignore the allocation of the RBs of the one or more RBGs that fall outside of the uplink subband(s) and consider the invalid RB allocation to be a valid partial RB allocation of RBs in the one or more RBGs that overlap with the uplink subband(s) of the SBFD partitioned slot.

Furthermore, in at least one of such instances, the RB allocation may include the allocation of one or more particular RBGs of the Type-0 PUSCH FDRA that partially fall outside, i.e., does not overlap with the uplink subband(s). For example, a particular RBG may include one or more RBs (e.g., two RBs) that overlap with uplink subband(s), and one or more RBs (e.g., two RBs) that overlap with one or more downlink subbands and/or one or more guard bands. In these instances, the UE may be configured to consider the one or more RBs of particular RBG that overlap with the uplink subband(s) to be a valid partial RB allocation. Thus, in such instances, the UE may consider the invalid RB allocation to be a valid partial RB allocation that include the RBs of the one or more such particular RBGs that overlap with the uplink subband(s), as well as any RBs of whole RBGs that are included in the invalid RB allocation that overlap with the uplink subband(s) of the SBFD partitioned slot.

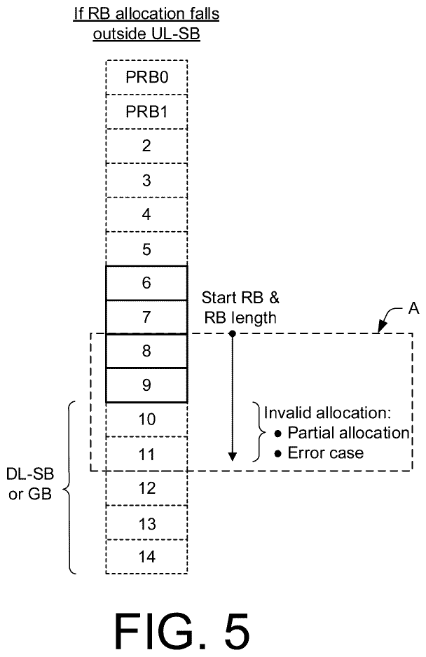

In other instances in which the UE is configured to salvage an invalid RB allocation for a Type-1 PUSCH FDRA that is designated by a start RB and a RB length, the UE may disregard any RB (PRB) of the invalid RB allocation that falls outside of the uplink subband(s) of a SBFD partitioned slot and then consider such an invalid RB allocation to be a valid partial RB allocation of RBs (PRBs) that fall within the uplink subband(s) of the SBFD partitioned slot. For example, with respect to Part A of FIG. 5, an invalid RB allocation may include a start RB and an RB length specifying an allocation range that covers PRBs #8-#11, in which PRBs #8 and #9 fall within the uplink subband(s) and PRBs #10 and #11 fall outside of the uplink subband(s) of the SBFD partitioned slot. Thus, the UE may consider the invalid RB allocation of PRBs (RBs) #8-#11 to be a valid partial RB allocation of PRBs (RBs) #8 and #9.

However, in alternative instances, the UE may be further configured to consider any invalid RB allocation that includes one or more RBs that are outside the uplink subband(s) of a SBFD partitioned slot to be an error case. As a result, the UE may disregard the invalid RB allocation because it is an error case.

In a second sub-scheme of the third proposed scheme in which PUSCH FDRA is not allowed outside uplink subbands, VRB-to-PRB mapping by the UE may exclude PRBs that are outside the uplink subband(s) for Type-1 PUSCH FDRA on SBFD partitioned slots/symbols. The excluded PRBs may be PRBs that belong to one or more downlink subbands and/or one or more guard bands. The network node may be configured to ensure that the allocated RBs and their corresponding mapping for a SBFD partitioned slot do not fall outside of the uplink subband(s) of the SBFD partitioned slot.

In a first sub-scheme of a fourth proposed scheme in which PUSCH FDRA is allowed outside uplink subbands, RB allocation of one or more RBs outside uplink subband(s) is allowed on SBFD partitioned slots/symbols. In such a sub-scheme, RBG flag for Type-0 PUSCH FDRA may be set by a network node to “1” for RBGs that fall outside uplink subband(s). Alternatively, the start RB and the RB length for the Type-1 PUSCH FDRA may be configured by the network node such that the RB allocation includes RBs outside the uplink subband(s). Thus, a new parameter may be configured by the network node and sent to the UE to indicate to the UE whether an RB allocation that includes one or more RBs outside the uplink subband(s) of a SBFD partitioned slot may be considered by the UE as a valid RB allocation or an invalid RB allocation. For example, a bit field may be introduced in the DCI to dynamically indicate if an RB allocation that includes one or more RBs outside the uplink subband(s) is to be considered as a valid RB allocation or an invalid RB allocation. Alternatively, a higher layer parameter (e.g., a RRC parameter) may be configured to semi-statically indicate that the RB allocation that includes one or more RBs outside the uplink subband(s) is to be considered as a valid RB allocation or an invalid RB allocation.

Thus, the UE may be configured to consider an RB allocation that includes one or more RBs outside the uplink subband(s) of a SBFD partitioned slot as an invalid RB allocation when the bit field is absent from the DCI. In some instances of this scenario, the UE may consider any allocated RBs of an invalid RB allocation that falls within, i.e., overlaps with the uplink subband(s) as a valid partial RB allocation. In other instances of this scenario, the UE may consider an RB allocation that includes one or more RBs that fall outside of the uplink subband(s) to be an invalid RB allocation that is an error case. As a result, the UE may disregard the invalid RB allocation because it is an error case.

However, when the bit field is present in the DCI, the UE may determine whether the RB allocation that includes one or more RBs outside of the uplink subband(s) of a SBFD partitioned slot is to be considered as a valid RB allocation or an invalid RB allocation based on a value included in the bit field. For example, when a first bit value (e.g., “0”) is present, the UE may be configured to consider an RB allocation that includes one or more RBs that are outside of the uplink subband(s) to be an invalid RB allocation. In some instances of this scenario, the UE may consider any allocated RBs of an invalid RB allocation that falls within, i.e., overlaps with the uplink subband(s) as a valid partial RB allocation. In other instances of this scenario, the UE may consider an RB allocation that includes one or more RBs that fall outside of the uplink subband(s) to be an invalid RB allocation that is an error case. As a result, the UE may disregard the invalid RB allocation because it is an error case.

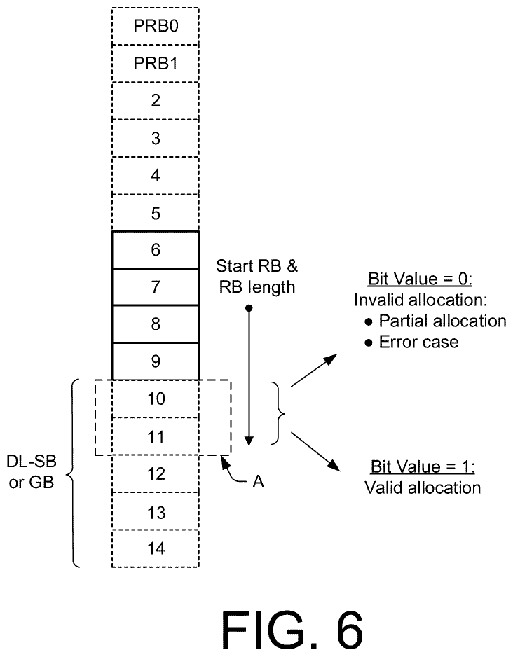

However, when the bit value that is present in the bit field of the DCI is a second value (e.g., “1”), the UE may be configured to consider an RB allocation that includes one or more RBs that are outside of the uplink subband(s) to be a valid RB allocation. For such a valid RB allocation, the UE may use all of allocated RBs of the RB allocation, i.e., the full allocation, for uplink data transmission regardless of whether each of the allocated RBs in the RB allocation is within or outside the uplink subband(s) of the SBFD partitioned slot. For example, as illustrated in FIG. 6 with respect to Type-1 PUSCH FDRA, an RB allocation that includes RBs that are outside of the uplink subband(s) of a SBFD partitioned slot (as shown in Part A) may be considered by the UE to be an invalid RB allocation or as a valid partial allocation when the bit value is “0”, and as a valid RB allocation when the bit value is “1”.

In a second sub-scheme of the fourth proposed scheme in which PUSCH FDRA is allowed outside uplink subbands, whether the bit value is set to a first value (e.g., “0”) or a second value (e.g., “1”) may also impact the VRB-to-PRB mapping for Type-1 PUSCH FDRA. For example, when the bit value is a first value (e.g., “0”) and the UE is configured to salvage, if possible, any invalid RB allocation as a partial RB allocation, the network node may also apply the second sub-scheme of the third proposed scheme for VRB-to-PRB mapping for Type-1 PDSCH FDRA. However, when the bit value is a second value (e.g., “1”) and the UE is configured to consider any RB allocation that includes one or more RBs that are outside of the uplink subband(s) to be a valid RB allocation, i.e., as a full allocation, the UE may apply existing VRB-to-PRB mapping functions and/or procedures as specified in the 3GPP specifications for Type-1 PDSCH FDRA.

In a fifth proposed scheme, the network (e.g., the network 130) may provide downlink and uplink subband layouts of a SBFD partitioned slot to the UE, such that the UE may cooperatively perform the operations of the first through the fourth proposed schemes in conjunction with a network node. In some instances, the downlink and uplink subband layouts may be provided to the UE via a higher layer parameter. For example, the downlink and uplink subband layouts may be provided to the UE via a RRC parameter, and early data transmission (EDT) pattern, a subband configuration pattern that specifies the uplink and downlink regions of SBFD partitioned slots, and/or so forth. In other instances, the downlink and uplink subband layouts may be provided to the UE via Layer-1 signaling, e.g., physical layer signaling. For example, the downlink and uplink subband layouts may be provided via dynamic indications that are based on resource allocations.

With respect to the further proposed schemes described below, PRB bundling, also referred to as precoding resource block groups (PRG) bundling, may be used to bundle groups of RBs, such as two RBs, four RBs, or an entire RB allocation of a SBFD partitioned slot. For example, the parameter prb-BundlingType within PDSCH-Config provided by a network node to a UE may configure either static or dynamic PRG bundling by the UE. Since the RBs within a PRG generally experiences similar channel conditions, a network node may apply the same precoding weights to all RBs within a PRG, while a UE may generate a separate channel estimate for each PRG.

For static bundling, PRG size is either 4 RBs or wideband. In the wideband case, the UE may assume that all allocated RBs in a SBFD partitioned slot belong to a single PRG. However, wideband PRG can only be selected with contiguous FDRA for both “static” and “dynamic” configurations. Furthermore, the network node may apply the same precoding to all allocated RBs with the same PRG bundle, and the UE may generate a single channel estimation for all allocated RBs in the same PRG bundle. Nevertheless, when prb-BundlingType is not provided to the UE, the UE may assume that the PRG size=2 since the default PRG size is two.

For “dynamic” bundling, two bundle size sets may be configured. For example, a “PRB Bundling Size Indicator” field within the DCI may be used to select between the bundle size sets, in which the indicator occupies one bit within the DCI Format 1_1 or Format 1_2. Thus, if the indicator is set to “0”, the UE is configured to select PRG size from “Bundle Size Set 2”, which may be either 4 RBs or wideband. However, if the indicator is set to “1” and a single value is configured for “Bundle Size Set 1”, the UE may use that value for the PRG size. Alternatively, if the indicator is set to “1” and two values are configured for “Bundle Size Set 1”, the UE may use the wideband value for the PRG size if the allocated RBs are contiguous and occupy more than half of the BWP. Otherwise, the UE may use a value of either two or four for the PRG size.

Nevertheless, there are some issues with PRG bundling. A first issue is that for the purpose of SBFD FDRA, a PRG with two or four RBs may overlap with both downlink subband(s) and uplink subband(s) at an edge between a downlink region and an uplink region of a SBFD partitioned slot. A second issue is that a wideband PRG is by existing convention configured for contiguous RB allocations. For example, if an RB allocation contains 10 RBs and the PRG size is set to wideband, the 10 RBs are required to be contiguous RBs within a downlink region of downlink subband(s) or an uplink region of uplink subband(s). Thus, enhancements are needed to use a wideband PRG for SBFD partitioned slot that has two or more non-contiguous downlink subbands.

Thus, in a sixth proposed scheme, a PRG may be configured by a network node so that when the PRG partially overlaps with uplink subband(s) of a SBFD partitioned slot, the non-overlapping RBs within the PRG may be allocated by the network node for downlink transmission. For example, when three of the four RBs in a PRG overlap with a downlink subband of a SBFD partitioned slot and one of the four RBs PRG overlaps with an uplink subband of the SBFD partition slot, the three RBs that overlap with the downlink subband, but which does not overlap with the uplink subband, may be allocated for downlink transmission from the network node to a UE. Accordingly, each PRG at an edge between the downlink subband(s) and uplink subband(s) may have a smaller number of RBs than PRGs that fall entirely within the downlink subband(s). Furthermore, a network node may apply the same precoding to the non-overlapping RBs within the PRG that partially overlaps with uplink subband(s) as applied to PRGs that fall entirely within the downlink subband(s).

According to a first sub-scheme of a seventh propose scheme, when the PRG size is configured as “wideband” for SBFD partitioned slots/symbols, the UE is always allocated contiguous RBs in one of the downlink subband(s). In other words, the PRG size may only be configured as wideband when the allocated RBs of a SBFD partitioned slot are contiguous within one of the downlink subband(s). Accordingly, for a PRB size of wideband, the UE is not configured with RBs across multiple downlink subbands for both static and dynamic PRG bundling. In some instances, the precoding and channel estimation procedure for a configured PRG with the PRG size of wideband may be existing procedures specified in the 3GPP specifications. For example, the same precoding may be applied for all the RBs within the configured wideband PRG. In another example, the UE may perform channel estimation on the configured wideband PRG.

According to a second sub-scheme of a seventh propose scheme, when the PRG size is configured as wideband on SBFD partitioned slots/symbols, a new threshold on the minimum RB size for dynamic selection may be defined. In some instances, for the case of dynamic selection in “Bundle Size Set 1”, the condition for selecting wideband may be modified. This modified condition may stipulate that when a “PRB bundling size indicator” is set to “1” and two values are configured for “Bundle Size set 1”, wideband may be dynamically selected for use if the allocated RBs in a SBFD partitioned slot meets any one of the following thresholds related to a minimum size of the allocated RBs: (1) the allocated RBs are more than half of the downlink BWP bandwidth of a corresponding SBFD partitioned slot; (2) the allocated RBs are more than half of a sum of all RBs in the downlink BWP of the corresponding SBFD partitioned slot; (3) the allocated RBs are equal to the sum of all RBs in downlink BWP of the corresponding SBFD partitioned slot; (4) the allocated RBs are more than half of the downlink subband bandwidth of the corresponding SBFD partitioned slot; or (5) the allocated RBs are equal to the bandwidth of a full downlink subband of the corresponding SBFD partitioned slot.

In an eighth proposed scheme, PRGs with a PRG size of wideband, i.e., wideband PRGs, may be configured to include non-contiguous PRGs across multiple downlink subbands of SBFD partitioned slots/symbols. Such a configuration of wideband PRG may apply to both static and dynamic PRG bundling. In some instances, wideband PRG may be selected if an RB allocation is contiguous over a concatenated (reindexed) sequence of downlink subband RBs. In other instances, wideband PRG may be dynamically selected if a contiguous RB allocation within each downlink subband meets a predetermined threshold. For example, the predetermined threshold for dynamically selecting wideband PRG may be one of (1) the allocated RBs of the contiguous RB allocation are more than half of the downlink BWP bandwidth of a corresponding SBFD partitioned slot; (2) the allocated RBs of the contiguous RB allocation are more than half of a sum of all RBs in the downlink BWP of the corresponding SBFD partitioned slot; (3) the allocated RBs of the contiguous RB allocation are equal to the sum of all RBs in downlink BWP of the corresponding SBFD partitioned slot; (4) the allocated RBs of the contiguous RB allocation are more than half of the downlink subband bandwidth of the corresponding SBFD partitioned slot; or (5) the allocated RBs of the contiguous RB allocation are equal to the bandwidth of a full downlink subband of the corresponding SBFD partitioned slot.

In additional instances, the UE may be configured to assume that the wideband PRGs within each downlink subband experience similar channel condition, and the network node may apply separate precoding to the wideband PRG within each downlink subband. In further instances, the UE may perform separate channel estimation for each downlink subband using a corresponding wideband PRG. In such instances, the UE may be configured to assume that a channel used for channel estimation is phase continuous over all RBs.

### Illustrative Implementation

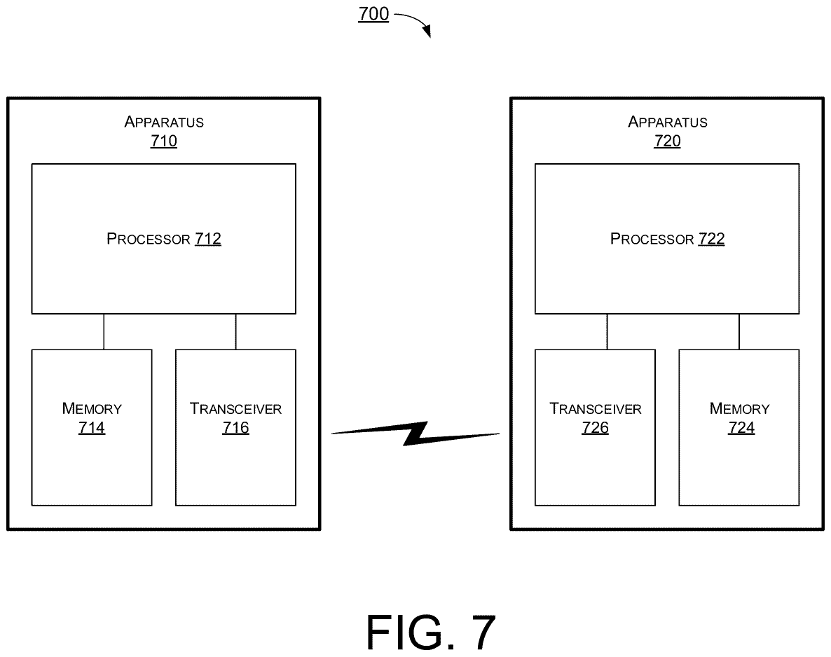

FIG. 7 illustrates an example communication system 700 having at least an example apparatus 710 and an example apparatus 720 in accordance with an implementation of the present disclosure. Each of apparatus 710 and apparatus 720 may perform various functions to implement schemes, techniques, processes and methods described herein pertaining to enhancements for PDSCH and PUSCH FDRA in SBFD, including the various schemes described above with respect to various proposed designs, concepts, schemes, systems and methods described above, including network environment 100, as well as processes described below.

Each of apparatus 710 and apparatus 720 may be a part of an electronic apparatus, which may be a network apparatus or a UE (e.g., UE 110), such as a portable or mobile apparatus, a wearable apparatus, a vehicular device or a vehicle, a wireless communication apparatus or a computing apparatus. For instance, each of apparatus 710 and apparatus 720 may be implemented in a smartphone, a smartwatch, a personal digital assistant, an electronic control unit (ECU) in a vehicle, a digital camera, or a computing equipment such as a tablet computer, a laptop computer or a notebook computer. Each of apparatus 710 and apparatus 720 may also be a part of a machine type apparatus, which may be an IoT apparatus such as an immobile or a stationary apparatus, a home apparatus, a roadside unit (RSU), a wire communication apparatus or a computing apparatus. For instance, each of apparatus 710 and apparatus 720 may be implemented in a smart thermostat, a smart fridge, a smart door lock, a wireless speaker or a home control center. When implemented in or as a network apparatus, apparatus 710 and/or apparatus 720 may be implemented in an eNodeB in an LTE, LTE-Advanced or LTE-Advanced Pro network or in a gNodeB or TRP in a 5G network, a B5G network, an NR network or an IoT network.

In some implementations, each of apparatus 710 and apparatus 720 may be implemented in the form of one or more integrated-circuit (IC) chips such as, for example and without limitation, one or more single-core processors, one or more multi-core processors, one or more complex-instruction-set-computing (CISC) processors, or one or more reduced-instruction-set-computing (RISC) processors. In the various schemes described above, each of apparatus 710 and apparatus 720 may be implemented in or as a network apparatus or a UE. Each of apparatus 710 and apparatus 720 may include at least some of those components shown in FIG. 7 such as a processor 712 and a processor 722, respectively, for example. Each of apparatus 710 and apparatus 720 may further include one or more other components not pertinent to the proposed scheme of the present disclosure (e.g., internal power supply, display device and/or user interface device), and, thus, such component(s) of apparatus 710 and apparatus 720 are neither shown in FIG. 7 nor described below in the interest of simplicity and brevity.

In one aspect, each of processor 712 and processor 722 may be implemented in the form of one or more single-core processors, one or more multi-core processors, or one or more CISC or RISC processors. That is, even though a singular term “a processor” is used herein to refer to processor 712 and processor 722, each of processor 712 and processor 722 may include multiple processors in some implementations and a single processor in other implementations in accordance with the present disclosure. In another aspect, each of processor 712 and processor 722 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 712 and processor 722 is a special-purpose machine specifically designed, arranged, and configured to perform specific tasks including those pertaining to techniques for UE configuration and scheduling in SBFD networks in accordance with various implementations of the present disclosure.

In some implementations, apparatus 710 may also include a transceiver 716 coupled to processor 712. Transceiver 716 may be capable of wirelessly transmitting and receiving data. In some implementations, transceiver 716 may be capable of wirelessly communicating with different types of wireless networks of different radio access technologies (RATs). In some implementations, transceiver 716 may be equipped with a plurality of antenna ports (not shown) such as, for example, four antenna ports. That is, transceiver 716 may be equipped with multiple transmit antennas and multiple receive antennas for multiple-input multiple-output (MIMO) wireless communications. In some implementations, apparatus 720 may also include a transceiver 726 coupled to processor 722. Transceiver 726 may include a transceiver capable of wirelessly transmitting and receiving data. In some implementations, transceiver 726 may be capable of wirelessly communicating with different types of UEs/wireless networks of different RATs. In some implementations, transceiver 726 may be equipped with a plurality of antenna ports (not shown) such as, for example, four antenna ports. That is, transceiver 726 may be equipped with multiple transmit antennas and multiple receive antennas for MIMO wireless communications.

In some implementations, apparatus 710 may further include a memory 714 coupled to processor 712 and capable of being accessed by processor 712 and storing data therein. In some implementations, apparatus 720 may further include a memory 724 coupled to processor 722 and capable of being accessed by processor 722 and storing data therein. Each of memory 714 and memory 724 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 714 and memory 724 may include a type of read-only memory (ROM) such as mask ROM, programmable ROM (PROM), erasable programmable ROM (EPROM) and/or electrically erasable programmable ROM (EEPROM). Alternatively, or additionally, each of memory 714 and memory 724 may include a type of non-volatile random-access memory (NVRAM) such as flash memory, solid-state memory, ferroelectric RAM (FeRAM), magnetoresistive RAM (MRAM) and/or phase-change memory.

Each of apparatus 710 and apparatus 720 may be a communication entity capable of communicating with each other using various proposed schemes in accordance with the present disclosure. For illustrative purposes and without limitation, a description of capabilities of apparatus 710, as a UE (e.g., UE 110), and apparatus 720 as a network node (e.g., network node 125) and/or another network component implementing one or more network-side functionalities described above of a network (e.g., network 130), is provided below in the context of example processes 800-1000.

### Illustrative Processes

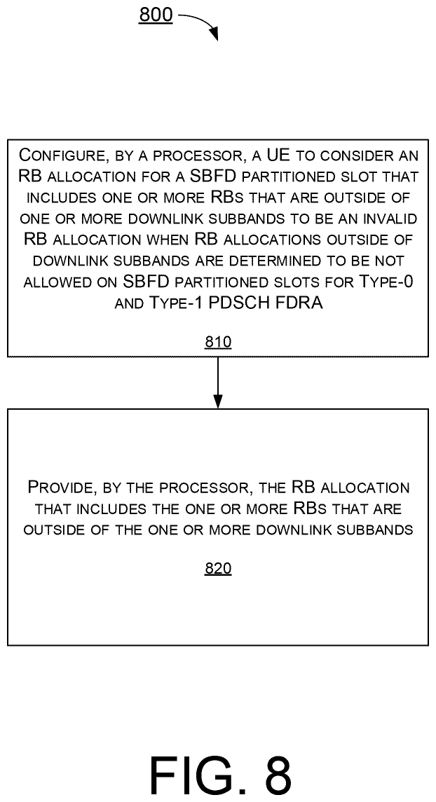

FIG. 8 is a flowchart of an example process 800 in accordance with an implementation of the present disclosure. The process 800 may represent an aspect of implementing various proposed designs, concepts, schemes, systems, and methods described above, whether partially or entirely, including those pertaining to those described above. More specifically, the process 800 may represent an aspect of the proposed concepts and schemes pertaining to enhancements for PDSCH and PUSCH FDRA in SBFD. The process 800 may include one or more operations, actions, or functions as illustrated by one or more blocks. Although illustrated as discrete blocks, various blocks of each process may be divided into additional blocks, combined into fewer blocks, or eliminated, depending on the desired implementation. Moreover, the blocks/sub-blocks of each process may be executed in the order shown in each figure or, alternatively in a different order. Furthermore, one or more of the blocks/sub-blocks of each process may be executed iteratively. The process 800 may be implemented by or in apparatus 710 and apparatus 720 as well as any variations thereof. Solely for illustrative purposes and without limiting the scope, the process 800 is described below in the context of apparatus 710 as a UE (e.g., UE 110) and apparatus 720 as a communication entity such as a network node or base station (e.g., network node 125 or another network node implementing one or more network-side functionalities described above) of an application server-side network (e.g., network 130).

At 810, process 800 may include processor 722 of apparatus 720, implemented in or as a part of a network node, configuring a UE to consider an RB allocation for a SBFD partitioned slot that includes one or more RBs that are outside of one or more downlink subbands to be an invalid RB allocation when RB allocations outside of downlink subbands are determined to be not allowed on SBFD partitioned slots for Type-0 and Type-1 PDSCH FDRA. Process 800 may proceed from 810 to 820.

At 820, process 800 may include processor 712 providing the RB allocation that includes the one or more RBs that are outside of the one or more downlink subbands.

In such implementations, process 800 may further include processor 722 configuring the UE to consider the invalid RB allocation to be a valid partial RB allocation of one or more particular RBs that fall within the one or more downlink subbands of the SBFD partitioned slot or to consider the invalid RB allocation as an error case that is disregarded.

In some implementations, process 800 may further include processor 722 configuring the UE to perform, for the Type-1 PDSCH FDRA, a VRB-to-PRB mapping that excludes PRBs that are outside of the one or more downlink subbands of the SBFD partitioned slot when the Type-1 PDSCH FDRA does not include interleaving, or to perform, for the Type-1 PDSCH FDRA, a VRB-to-PRB mapping separately for each downlink subband of the SBFD partitioned slot when the Type-1 PDSCH FDRA includes interleaving.

In some implementations, process 800 may further include processor 722 configuring a parameter that indicates to the UE whether the UE is to consider the RB allocation that includes the one or more RBs that are outside the one or more downlink subbands of the SBFD partitioned slot to be a valid RB allocation when RB allocations outside of the downlink subbands are determined to be allowed on the SBFD partitioned slots for the Type-0 and the Type-1 PDSCH FDRA, and providing scheduling DCI to the UE that either includes or excludes the parameter.

In some implementations, process 800 may further include processor 722 providing the RB allocation that includes the one or more RBs that are outside the one or more downlink subbands to the UE, and configuring the UE to consider the RB allocation that includes the one or more RBs that are outside the one or more downlink subbands of the SBFD partitioned slot to be an invalid RB allocation when the parameter is absent from the scheduling DCI.

In such implementations, process 800 may further include processor 722 configuring the UE to consider the invalid RB allocation to be a valid partial RB allocation of one or more particular RBs that fall within the one or more downlink subbands of the SBFD partitioned slot or to consider the invalid RB allocation as an error case that is disregarded.

In some implementations, process 800 may further include processor 722 configuring the UE to consider the RB allocation that includes the one or more RBs that are outside the one or more downlink subbands of the SBFD partitioned slot to be an invalid RB allocation when the parameter is present in the scheduling DCI and has a first value, and to consider the RB allocation that includes the one or more RBs that are outside the one or more downlink subbands of the SBFD partitioned slot to be a valid RB allocation when the parameter is present in the scheduling DCI and has a second value.

In such implementations, process 800 may further include processor 722 configuring the UE to consider the invalid RB allocation to be a valid partial RB allocation of one or more particular RBs that fall within the one or more downlink subbands of the SBFD partitioned slot or to consider the invalid RB allocation as an error case that is disregarded.

In some implementations, when the parameter has the first value and the UE considers the invalid RB allocation to be the valid partial RB allocation, the UE is further configured to perform, for the Type-1 PDSCH FDRA, a VRB-to-PRB mapping that excludes PRBs that are outside of the one or more downlink subbands of the SBFD partitioned slot when the Type-1 PDSCH FDRA does not include interleaving, or to perform, for the Type-1 PDSCH FDRA, an individual VRB-to-PRB mapping separately for each downlink subband of the SBFD partitioned slot when the Type-1 PDSCH FDRA includes interleaving, and when the parameter has the second value and the UE considers the RB allocation to a valid RB allocation, the UE is further configured to perform, for the Type-1 PDSCH FDRA, an existing VRB-to-PRB mapping procedure.

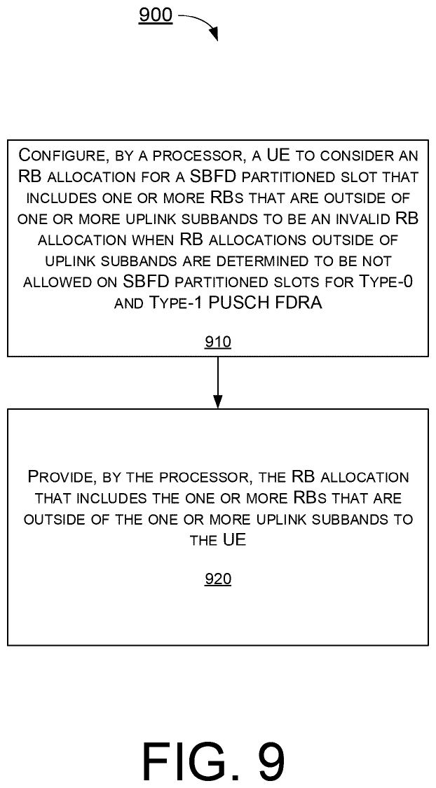

FIG. 9 is a flowchart of an example process 900 in accordance with an implementation of the present disclosure. The process 900 may represent an aspect of implementing various proposed designs, concepts, schemes, systems, and methods described above, whether partially or entirely, including those pertaining to those described above. More specifically, the process 900 may represent an aspect of the proposed concepts and schemes pertaining to enhancements for PDSCH and PUSCH FDRA in SBFD. The process 900 may include one or more operations, actions, or functions as illustrated by one or more blocks. Although illustrated as discrete blocks, various blocks of each process may be divided into additional blocks, combined into fewer blocks, or eliminated, depending on the desired implementation. Moreover, the blocks/sub-blocks of each process may be executed in the order shown in each figure or, alternatively in a different order. Furthermore, one or more of the blocks/sub-blocks of each process may be executed iteratively. The process 900 may be implemented by or in apparatus 710 and apparatus 720 as well as any variations thereof. Solely for illustrative purposes and without limiting the scope, the process 900 is described below in the context of apparatus 710 as a UE (e.g., UE 110) and apparatus 720 as a communication entity such as a network node or base station (e.g., network node 125 or another network node implementing one or more network-side functionalities described above) of an application server-side network (e.g., network 130).

At 910, process 900 may include processor 722 of apparatus 720, implemented in or as a part of a network node, configuring a UE to consider an RB allocation for a SBFD partitioned slot that includes one or more RBs that are outside of one or more uplink subbands to be an invalid RB allocation when RB allocations outside of uplink subbands are determined to be not allowed on SBFD partitioned slots for Type-0 and Type-1 PUSCH FDRA. Process 900 may proceed from 910 to 920.

At 920, process 900 may include processor 712 providing the RB allocation that includes the one or more RBs that are outside of the one or more uplink subbands to the UE.

In such implementations, process 900 may further include processor 722 configuring the UE to consider the invalid RB allocation to be a valid partial RB allocation of one or more particular RBs that fall within the one or more uplink subbands of the SBFD partitioned slot or to consider the invalid RB allocation as an error case that is disregarded.

In some implementations, process 900 may further include processor 722 configuring the UE to perform, for the Type-1 PUSCH FDRA, a VRB-to-PRB mapping that excludes PRBs that are outside of the one or more uplink subbands of the SBFD partitioned slot.

In some implementations, process 900 may further include processor 722 configuring a parameter that indicates to the UE whether the UE is to consider the RB allocation that includes the one or more RBs that are outside the one or more uplink subbands of the SBFD partitioned slot to be a valid RB allocation when RB allocations outside of the uplink subbands are determined to be allowed on the SBFD partitioned slots for the Type-0 and the Type-1 PUSCH FDRA, and providing scheduling DCI to the UE that either includes or excludes the parameter.

In some implementations, process 900 may further include processor 722 providing the RB allocation that includes the one or more RBs that are outside the one or more uplink subbands to the UE, and configuring the UE to consider the RB allocation that includes the one or more RBs that are outside the one or more uplink subbands of the SBFD partitioned slot to be an invalid RB allocation when the parameter is absent from the scheduling DCI.

In some implementations, process 900 may further include processor 722 configuring the UE to consider the invalid RB allocation to be a valid partial RB allocation of one or more particular RBs that fall within the one or more uplink subbands of the SBFD partitioned slot or to consider the invalid RB allocation as an error case that is disregarded.

In some implementations, process 900 may further include processor 722 configuring the UE to consider the RB allocation that includes the one or more RBs that are outside the one or more uplink subbands of the SBFD partitioned slot to be an invalid RB allocation when the parameter is present in the scheduling DCI and has a first value, and to consider the RB allocation that includes the one or more RBs that are outside the one or more uplink subbands of the SBFD partitioned slot to be a valid RB allocation when the parameter is present in the scheduling DCI and has a second value.

In such implementations, process 900 may further include processor 722 configuring the UE to consider the invalid RB allocation to be a valid partial RB allocation of one or more particular RBs that fall within the one or more uplink subbands of the SBFD partitioned slot or to consider the invalid RB allocation as an error case that is disregarded.

In some implementations, when the parameter has the first value and the UE considers the invalid RB allocation to be the valid partial RB allocation, the UE is further configured to perform, for the Type-1 PUSCH FDRA, a VRB-to-PRB mapping that excludes PRBs that are outside of the one or more uplink subbands of the SBFD partitioned slot, and when the parameter has the second value and the UE considers the RB allocation to a valid RB allocation, the UE is further configured to perform, for the Type-1 PUSCH FDRA, an existing VRB-to-PRB mapping procedure.

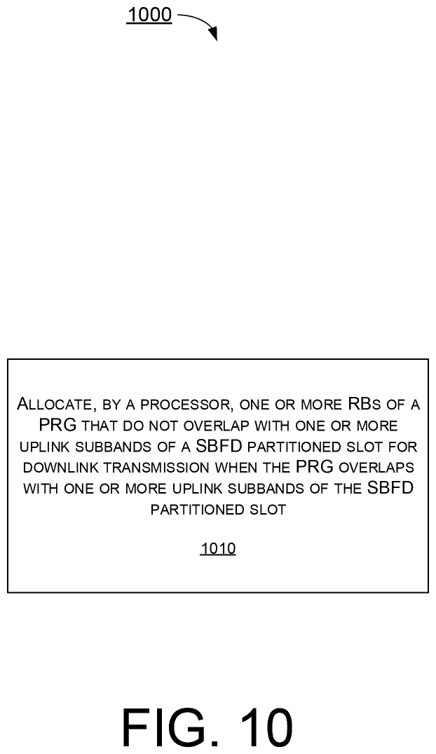

FIG. 10 is a flowchart of an example process 1000 in accordance with an implementation of the present disclosure. The process 1000 may represent an aspect of implementing various proposed designs, concepts, schemes, systems, and methods described above, whether partially or entirely, including those pertaining to those described above. More specifically, the process 1000 may represent an aspect of the proposed concepts and schemes pertaining to enhancements for PDSCH and PUSCH FDRA in SBFD. The process 1000 may include one or more operations, actions, or functions as illustrated by one or more blocks. Although illustrated as discrete blocks, various blocks of each process may be divided into additional blocks, combined into fewer blocks, or eliminated, depending on the desired implementation. Moreover, the blocks/sub-blocks of each process may be executed in the order shown in each figure or, alternatively in a different order. Furthermore, one or more of the blocks/sub-blocks of each process may be executed iteratively. The process 1000 may be implemented by or in apparatus 710 and apparatus 720 as well as any variations thereof. Solely for illustrative purposes and without limiting the scope, the process 1000 is described below in the context of apparatus 710 as a UE (e.g., UE 110) and apparatus 720 as a communication entity such as a network node or base station (e.g., network node 125 or another network node implementing one or more network-side functionalities described above) of an application server-side network (e.g., network 130).

At 1010, process 1000 may include processor 722 of apparatus 720, implemented in or as a part of a network node, performing at least one operation of a plurality of operations that comprise allocating one or more RBs of a PRG that do not overlap with one or more uplink subbands of a SBFD partitioned slot for downlink transmission when the PRG overlaps with one or more uplink subbands of the SBFD partitioned slot.

In some implementations, the plurality of operations may further comprise in response to a PRG size of the PRG being configured as wideband, always allocating contiguous RBs in one of one or more downlink subbands of the SBFD partitioned slot to a UE, in response to the PRG size of the PRG being configured as wideband and multiple values being configured for a bundle size set of the PRG, dynamically select wideband for use when allocated RBs in the SBFD partitioned slot meets any one of a plurality of thresholds related a minimum size of the allocated RBs, applying a PRG size of wideband to cover non-contiguous PRGs across multiple downlink subbands of the SBFD partitioned slot.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
configuring, by a processor, a user equipment (UE) to consider a resource block (RB) allocation for a subband full duplex (SBFD) partitioned slot that includes one or more RBs that are outside of one or more downlink subbands to be an invalid RB allocation when RB allocations outside of downlink subbands are determined to be not allowed on SBFD partitioned slots for Type-0 and Type-1 physical data shared channel (PDSCH) frequency domain resource allocation (FDRA); and
providing, by the processor, the RB allocation that includes the one or more RBs that are outside of the one or more downlink subbands.

2. The method of claim 1, further comprising, configuring, by the processor, the UE to consider the invalid RB allocation to be a valid partial RB allocation of one or more particular RBs that fall within the one or more downlink subbands of the SBFD partitioned slot or to consider the invalid RB allocation as an error case that is disregarded.

3. The method of claim 1, further comprising, configuring by the processor, the UE to perform, for the Type-1 PDSCH FDRA, a virtual resource block-to-physical resource block (VRB-to-PRB) mapping that excludes PRBs that are outside of the one or more downlink subbands of the SBFD partitioned slot when the Type-1 PDSCH FDRA does not include interleaving, or to perform, for the Type-1 PDSCH FDRA, an individual VRB-to-PRB mapping separately for each downlink subband of the SBFD partitioned slot when the Type-1 PDSCH FDRA includes interleaving.

4. The method of claim 1, further comprising:
configuring, by the processor, a parameter that indicates to the UE whether the UE is to consider the RB allocation that includes the one or more RBs that are outside the one or more downlink subbands of the SBFD partitioned slot to be a valid RB allocation when RB allocations outside of the downlink subbands are determined to be allowed on the SBFD partitioned slots for the Type-0 and the Type-1 PDSCH FDRA; and
providing, by the processor, scheduling downlink control information (DCI) to the UE that either includes or excludes the parameter.

5. The method of claim 4, further comprising:
providing, by the processor, the RB allocation that includes the one or more RBs that are outside the one or more downlink subbands to the UE; and
configuring, by the processor, the UE to consider the RB allocation that includes the one or more RBs that are outside the one or more downlink subbands of the SBFD partitioned slot to be an invalid RB allocation when the parameter is absent from the scheduling DCI.

6. The method of claim 5, further comprising, configuring, by the processor, the UE to consider the invalid RB allocation to be a valid partial RB allocation of one or more particular RBs that fall within the one or more downlink subbands of the SBFD partitioned slot or to consider the invalid RB allocation as an error case that is disregarded.

7. The method of claim 6, further comprising, configuring, by the processor, the UE to consider the RB allocation that includes the one or more RBs that are outside the one or more downlink subbands of the SBFD partitioned slot to be an invalid RB allocation when the parameter is present in the scheduling DCI and has a first value, and to consider the RB allocation that includes the one or more RBs that are outside the one or more downlink subbands of the SBFD partitioned slot to be a valid RB allocation when the parameter is present in the scheduling DCI and has a second value.

8. The method of claim 7, further comprising, configuring, by the processor, the UE to consider the invalid RB allocation to be a valid partial RB allocation of one or more particular RBs that fall within the one or more downlink subbands of the SBFD partitioned slot or to consider the invalid RB allocation as an error case that is disregarded.

9. The method of claim 8, wherein when the parameter has the first value and the UE considers the invalid RB allocation to be the valid partial RB allocation, the UE is further configured to perform, for the Type-1 PDSCH FDRA, a virtual resource block-to-physical resource block (VRB-to-PRB) mapping that excludes PRBs that are outside of the one or more downlink subbands of the SBFD partitioned slot when the Type-1 PDSCH FDRA does not include interleaving, or to perform, for the Type-1 PDSCH FDRA, an individual VRB-to-PRB mapping separately for each downlink subband of the SBFD partitioned slot when the Type-1 PDSCH FDRA includes interleaving, and wherein when the parameter has the second value and the UE considers the RB allocation to be a valid RB allocation, the UE is further configured to perform, for the Type-1 PDSCH FDRA, an existing VRB-to-PRB mapping procedure.

10. A method, comprising:
configuring, by a processor, a user equipment (UE) to consider a resource block (RB) allocation for a subband full duplex (SBFD) partitioned slot that includes one or more RBs that are outside of one or more uplink subbands to be an invalid RB allocation when RB allocations outside of uplink subbands are determined to be not allowed on SBFD partitioned slots for Type-0 and Type-1 physical uplink shared channel (PUSCH) frequency domain resource allocation (FDRA); and
providing, by the processor, the RB allocation that includes the one or more RBs that are outside of the one or more uplink subbands to the UE.

11. The method of claim 10, further comprising, configuring, by the processor, the UE to consider the invalid RB allocation to be a valid partial RB allocation of one or more particular RBs that fall within the one or more uplink subbands of the SBFD partitioned slot or to consider the invalid RB allocation as an error case that is disregarded.

12. The method of claim 10, further comprising, configuring by the processor, the UE to perform, for the Type-1 PUSCH FDRA, a virtual resource block-to-physical resource block (VRB-to-PRB) mapping that excludes PRBs that are outside of the one or more uplink subbands of the SBFD partitioned slot.

13. The method of claim 10, further comprising:
configuring, by the processor, a parameter that indicates to the UE whether the UE is to consider the RB allocation that includes the one or more RBs that are outside the one or more uplink subbands of the SBFD partitioned slot to be a valid RB allocation when RB allocations outside of the uplink subbands are determined to be allowed on the SBFD partitioned slots for the Type-0 and the Type-1 PUSCH FDRA; and
providing, by the processor, scheduling downlink control information (DCI) to the UE that either includes or excludes the parameter.

14. The method of claim 13, further comprising:
providing, by the processor, the RB allocation that includes the one or more RBs that are outside the one or more uplink subbands to the UE; and
configuring, by the processor, the UE to consider the RB allocation that includes the one or more RBs that are outside the one or more uplink subbands of the SBFD partitioned slot to be an invalid RB allocation when the parameter is absent from the scheduling DCI.

15. The method of claim 14, further comprising, configuring, by the processor, the UE to consider the invalid RB allocation to be a valid partial RB allocation of one or more particular RBs that fall within the one or more uplink subbands of the SBFD partitioned slot or to consider the invalid RB allocation as an error case that is disregarded.

16. The method of claim 15, further comprising, configuring, by the processor, the UE to consider the RB allocation that includes the one or more RBs that are outside the one or more uplink subbands of the SBFD partitioned slot to be an invalid RB allocation when the parameter is present in the scheduling DCI and has a first value, and to consider the RB allocation that includes the one or more RBs that are outside the one or more uplink subbands of the SBFD partitioned slot to be a valid RB allocation when the parameter is present in the scheduling DCI and has a second value.

17. The method of claim 16, further comprising, configuring, by the processor, the UE to consider the invalid RB allocation to be a valid partial RB allocation of one or more particular RBs that fall within the one or more uplink subbands of the SBFD partitioned slot or to consider the invalid RB allocation as an error case that is disregarded.

18. The method of claim 17, wherein when the parameter has the first value and the UE considers the invalid RB allocation to be the valid partial RB allocation, the UE is further configured to perform, for the Type-1 PUSCH FDRA, a virtual resource block-to-physical resource block (VRB-to-PRB) mapping that excludes PRBs that are outside of the one or more uplink subbands of the SBFD partitioned slot, and wherein when the parameter has the second value and the UE considers the RB allocation to be a valid RB allocation, the UE is further configured to perform, for the Type-1 PUSCH FDRA, an existing VRB-to-PRB mapping procedure.

19. An apparatus, comprising:
a transceiver configured to communicate wirelessly; and
a processor coupled to the transceiver and configured to perform at least one operation of a plurality of operations, the plurality of operations comprising:
allocating one or more RBs of a precoding resource block group (PRG) that do not overlap with one or more uplink subbands of a subband full duplex (SBFD) partitioned slot for downlink transmission when the PRG overlaps with one or more uplink subbands of the SBFD partitioned slot.

20. The apparatus of claim 19, wherein the plurality of operations further comprise:
in response to a PRG size of the PRG being configured as wideband, always allocating contiguous RBs in one of one or more downlink subbands of the SBFD partitioned slot to a user equipment (UE);
in response to the PRG size of the PRG being configured as wideband and multiple values being configured for a bundle size set of the PRG, dynamically select wideband for use when allocated RBs in the SBFD partitioned slot meets any one of a plurality of thresholds related a minimum size of the allocated RBs; and
applying a PRG size of wideband to cover non-contiguous PRGs across multiple downlink subbands of the SBFD partitioned slot.
